(19) United States
(12) Patent Application Publication
(10) Pub. No.: US 2014/0344027 A1
(43) Pub. Date: Nov. 20, 2014

(54) METHOD AND SYSTEM FOR PROVIDING INFORMATION ABOUT PARKING FEES IN METERED CAR PARKS

(71) Applicant: GM GLOBAL TECHNOLOGY OPERATIONS LLC, Detroit, MI (US)

(72) Inventors: Bjoern Frank, Wiesbaden (DE); Harald Dick, Flonheim (DE)

(73) Assignee: GM GLOBAL TECHNOLOGY OPERATIONS LLC, Detroit, MI (US)

(21) Appl. No.: 14/280,214

(22) Filed: May 16, 2014

(30) Foreign Application Priority Data
May 16, 2013 (DE) 102013008373.7

(51) Int. Cl. G06Q 30/02

(52) U.S. Cl. CPC G06Q 30/0284; G06Q 2240/00
USPC 705/13

(57) ABSTRACT

The present disclosure relates to a method for providing information about parking fees in a metered car park. The method includes on-board detection as to whether a motor vehicle is in a metered car park, on-board detection as to whether the motor vehicle is parked, in case the motor vehicle is in a metered car park, and establishing a wireless link to a car park fee center associated with the car park and receiving information about the parking fees via a wireless link, in case the motor vehicle is parked.

### CROSS REFERNCE TO RELATED APPLICATION

This application claims priority to German Patent Application No. 102013008373.7 filed May 16, 2013, which is incorporated herein by reference in its entirety.

### TECHNICAL FIELD

The technical field relates to a method and system for providing information about parking fees in metered car parks, which enable a user of a motor vehicle to access data of a car park fee center associated with the car park.

### BACKGROUND

Conventional motor vehicles have a plurality of driver assistance systems incorporated in them which are intended to support a user of the motor vehicle in various situations during operation of the vehicle.

With the increasing use of active driver assistance systems in motor vehicles the number of sensors in a motor vehicle also increases. As such means are provided for orientation as well as means for communication, for example for car-to-X-communication. Car-to-X-communication is understood to include communication techniques with which the safety and economic efficiency of motor vehicles shall be improved and adapted to suit the increasing mobility and density in road traffic. Attention shall, for example, be drawn to black ice or aquaplaning, to road accidents and road works, to high traffic density and other impairments.

Also conventional motor vehicles increasingly have parking assistance systems built into them which are designed to support parking in an existing parking space or a gap and/or leaving a parking space with the aid of an electronic system. Furthermore such parking assistance systems are designed to ascertain whether parking spaces for parking the respective motor vehicle are adequate. Also when performing a parking operation in a metered car park it may be necessary for the user to leave his vehicle in order to buy a parking ticket at a car park fee center such as a ticket machine. The ticket corresponds to the zone tariff of the chosen car park, the parking time and the desired parking duration. The user then returns with this ticket to the parking space in order to deposit the ticket in an easily visible spot on top of the dashboard in his motor vehicle. This rather time-consuming activity can be avoided by using known systems which include a mobile phone in the process. The parking time is chosen by entering the amount to be paid via a service line of the car park operator, and the respective parking fee is credited to the account of the respective car park operator. With this system the user is debited either via a value card or via a telecommunications account.

The DE 10 2005 032 718 A1 specification has disclosed a system for the cashless payment of parking fees via a wireless link between a mobile terminal of a user or the motor vehicle and a car park fee center associated with the car park. Using the mobile terminal the user manually enters parking data such as the zone and number of the chosen car park, the desired parking duration as well as date and time of the start of parking.

There is a need to provide an improved method and system for providing information about parking fees in a metered car park, which is of simple design and with which the comfort for a user can be distinctly increased.

### SUMMARY

According to one embodiment of the present disclosure this need is met by a method for providing information about parking fees in a metered car park (i) an initial on-board detection to determine whether a motor vehicle is present in a metered car park, and (ii) subsequently when the motor vehicle is in a metered car park, an on-board detection to determine whether the motor vehicle is parked. In case the motor vehicle is parked a wireless link is established to a car park fee center associated with the car park and information is received regarding the parking fees via the wireless link.

Parking data such as zone and number of the selected car park is acquired directly with the aid of functions and components of the motor vehicle and is used to provide information to the user on parking fees on the basis of this parking data. On-board means that these steps are executed directly by components and functions of the motor vehicle. The car park fee center is understood to mean a facility firmly associated with the respective car park and which provides data in particular on the parking fees such as a parking ticket.

The method as described herein provides information about parking fees in a metered car park has the advantage that it is of simple design and is capable of distinctly increasing the comfort for a user. This means that it is no longer necessary for a user of the motor vehicle to separately enter parking data since the parking data is directly detected via components and functions of the motor vehicle and can be automatically made available to the user so that the comfort for the user is distinctly increased. Furthermore, the method can be realized and executed by components and functions of known driver assistance systems for conventional motor vehicles can consequently be implemented therein in a simple and low-cost manner, thus resulting in a simple design of the method without requiring expensive and costly conversions. As such it is possible to utilize communication means present in conventional motor vehicles such as car-to-X-communication and means for orientation such as camera systems, in order to detect an actual position of the motor vehicle, or to establish a wireless link to the car park fee center associated with the car park. Further, apart from information about parking fees, further information e.g. on the infrastructure of the car park, can be received.

The step of detecting on-board whether the motor vehicle is in a metered car park may include a comparison of the actual vehicle position with known map data. As such the actual vehicle position can be derived via known and commonly used means for orientation such as camera systems and compared with data about a momentary vehicle environment which can be retrieved for example from data of a digital map thereby realizing this step in a simple and inexpensive manner through known and commonly used components in conventional driver assistance systems.

The known map data may be data on a digital map and additional information which may be POI information and/or web information. POI (point of interest) means locations which may be important to the user of a map or a navigation system and which in the map are normally represented by small icons. As such a digital map may be used to scan in digital map material which is further specified by POI information and/or web information so that accuracy and precision of the step of on-board detection, as to whether the motor vehicle is in a metered car park, can be further improved.

The step of detecting as to whether the motor vehicle is parked can also be effected on the basis of data from vehicle sensors. As such it is possible, on the basis of data obtained from sensors present in conventional motor vehicles, to ascertain in a simple and inexpensive manner as to whether the vehicle has been parked, so that the step of detecting as to whether the vehicle has been parked may be designed in a simple way without requiring further components or expensive and costly conversions.

According to one embodiment the data from vehicle sensors may be data of a hand brake sensor and/or data of an engine control. Since hand brakes, also called “parking” brakes or “securing” brakes, are normally operated only to secure a parked vehicle, and a vehicle speed can be obtained from data of an engine control, it follows that one can also determine as to whether the motor vehicle is at all moving. That is why this data is eminently suitable for indicating that the vehicle is parked. Since conventional motor vehicles are equipped with a hand brake sensor and an engine control this data can be detected in a simple and inexpensive manner also by the already existing functions and components in the vehicle.

Also the step of receiving information about parking fees may further include the following steps: it can be detected whether the motor vehicle is not locked whereby this information is provided on a screen of the information/entertainment system of the motor vehicle in case the motor vehicle is locked, and on a display unit of a mobile terminal in case the motor vehicle is locked. The mobile terminal may be a user-portable unit, for example a mobile phone, a PDA (personal digital assistant) or a smartphone. Also conventional motor vehicles are increasingly equipped with information/entertainment systems which include a plurality of wireless devices and which are utilized to provide entertainment programs and information programs for the user of a motor vehicle. For example information programs may be provided which support a user of the motor vehicle in a variety of driving situations through retrievable information or autonomously issued hints and/or which automatically execute actions regarding the driving behavior of the motor vehicle. The user is thus provided with information about commonly used devices and/or components of a conventional motor vehicle, independently of whether he has already left the motor vehicle, whereby the comfort of the user can be further improved. The step of detecting as to whether the vehicle is locked, may be effected in a simple and inexpensive manner on the basis of data or signals of a door sensor and/or a central locking system and thus on the basis of components and functions present in conventional motor vehicles. Further, apart from information about parking fees, the user may also be provided with further information about the infrastructure of the car park or a maximum possible parking duration. This data can be made available to applications available on the mobile terminal, such as to an application for finding the way back to a parked motor vehicle. Provisions may also be made for the information to be provided via an audible signal, in particular a voice signal.

According to a further embodiment the method may include the following steps: for example, the user can choose whether a parking ticket should be acquired, and the parking fee can be paid for via the wireless link in a cashless manner, if a parking ticket is to be bought. The user is thus if so desired, offered the opportunity to pay without cash in a simple and comfortable manner for his parking with the aid of the information/entertainment system of the motor vehicle or the mobile terminal, thereby avoiding unnecessary walks to a car park fee center such as a car park ticket machine. It is feasible to acquire a parking ticket for a desired parking duration directly at the start of parking or to pay the accrued parking fee in a cashless manner when leaving the car park, wherein driving the motor vehicle out of the car park can be detected again in a simple and inexpensive manner on the basis of vehicle sensors.

Moreover the method may include the optional step of the user selecting in advance as to whether to execute the method. The user is thus given the possibility to execute the method according to preselected procedure, thereby avoiding unnecessary sensory overload or unnecessary computing effort.

The present disclosure also proposes a computer program which when executed on a computing unit of a motor vehicle instructs the computing unit to execute an above-described method. A computer-readable medium may thus be provided on which such a computer program is stored. A computer program of this kind has the advantage that with it a method for providing information about parking fees in a metered car park can be provided, which is designed in a simple manner and with which the comfort for the user can be distinctly improved. As such a user of a motor vehicle is no longer required to separately enter parking data, since the parking data can be detected directly via components and functions of the motor vehicle and be made automatically available to the user so that the comfort for the user is distinctly improved. Further the method can be realized by components and functions of driver assistance systems known for conventional motor vehicles and can be implemented in a simple and inexpensive manner, resulting in a simple design.

The present disclosure also provides for a system for providing information about parking fees on a metered car park. The system includes a first means on-board the vehicle for detecting as to whether a motor vehicle is present in a metered car park, a second means on-board the vehicle for detecting whether the motor vehicle is parked, and an interface for establishing a wireless link to a car park fee center associated with the car park and an indicating means for providing information about parking fees. Onboard the vehicle means that include these components or functions of a motor vehicle. A system of this kind has the advantage that it is of simple design and that with it the comfort for the user can be distinctly improved. As such the system is designed such that the parking data is detected by components and functions of the vehicle thereby obviating a separate entry of parking data by a user of the motor vehicle and making this data automatically available to the user so that the comfort for the user can be distinctly improved. Further the system may be based on components and functions of driver assistance systems known for conventional motor vehicles, and can thus be realized in a simple and inexpensive manner and implemented in the same, so that the system is designed in a simple manner without requiring expensive and costly conversions. A car park fee center is further understood to mean a facility for example a car park ticket machine which is firmly associated with the respective car park and provides data, in particular about parking fees.

The first means may include a memory for storing a digital map, means for orientation, a web interface as well as a first evaluation unit for matching an actual vehicle position with known map data. Known map data is understood to mean data of the digital map as well as additional information which is POI information and/or web information. POI (point of interest) stands for locations which could be of importance to the user of a map or navigation system and which is represented in the map by small icons. The first means is therefore designed to derive the actual vehicle position via commonly used means for orientation such as camera systems and to compare this with data about a momentary vehicle environment, in particular data of a digital map so that the first means can be realized in a simple and inexpensive manner through known and commonly used components of conventional driver assistance systems. The means for orientation may be a module for position determination such as a GPS (global positioning system) module and/or a GLONASS (global navigation satellite system) module and/or a compass module and/or a Galileo module and/or an IRNSS (Indian regional navigation satellite system) module and/or an EGNOS (European geostationary navigation overlay service) module and/or a GAGAN (GPS added Geo augmented navigation) module and/or a WAAS (wide area augmentation system) module. The digital map can further be used to scan in digital map material which can be made more precise through the additional information, in particular through POI information and/or through data obtained via the web interface.

According to one embodiment the second means includes a hand brake sensor, an engine control and a second evaluation unit for evaluating the data of the hand brake sensor and/or the engine control. Since hand brakes, also called securing brakes, are usually only operated in order to secure a parked vehicle and data of an engine control can be used to obtain a vehicle speed, it is possible to deduct as to whether the vehicle is at all moving, and these components can be used as a basis for ascertaining in a simple and inexpensive manner whether the motor vehicle has indeed been parked. Since hand brake sensors an engine control are components of conventional motor vehicles the second means is designed so as to realize this in a simple and inexpensive manner through components and functions of a conventional motor vehicle without requiring further components or expensive and costly conversions. Furthermore the second evaluation unit may alternatively designed to evaluate the data through further sensors present in a conventional motor vehicle and thereby to detect whether the motor vehicle is parked.

Further the indicating element may be a screen of an information/entertainment system of the motor vehicle or a display unit on a mobile terminal The mobile terminal may be a unit portable by a user of the motor vehicle such as a mobile phone, a PDA (personal digital assistant) or a smartphone. Conventional motor vehicles are increasingly equipped with infotainment systems including a plurality of in particular wireless devices and serving to provide entertainment programs and/or information programs for the users of a motor vehicle. For example, information programs can be provided which support a driver of the motor vehicle in a variety of driving situations through retrievable information or autonomously issued hints and/or automatically execute actions relating to the driving behavior of the motor vehicle. Thus information about the parking fees can be displayed and thus provided to a user of the motor vehicle, independently of whether he has already left his motor vehicle and has locked it, thereby distinctly improving the comfort for the user. Furthermore other information can be provided, relating to the infrastructure of the car park or relating to the maximum possible parking duration: It is also feasible to make the information on the mobile terminal available to further applications such as an application for finding the way back to a motor vehicle in a car park. Provision may also be made to design the system such that information is provided through an acoustic signal, in particular through a voice signal.

Furthermore the system may include a first selection unit for the user to select whether a parking ticket shall be bought, and a third means for cashless payment of the parking fee via a wireless link. A user of the motor vehicle is thus offered the opportunity to pay the parking fee without cash in a simple and comfortable manner saving him the superfluous walk to a car park fee center such as a parking ticket machine. Since no further separate entry of parking data by the user is required comfort for the user is further increased. It is feasible to buy a valid parking ticket for a certain parking duration immediately upon parking or to pay the accrued parking fee when leaving the car park. The third means may be integrated with the infotainment system of the motor vehicle as well as with the mobile terminal. The system may further include a reading/writing device for a card with payment function. This card may be configured as a credit card, EC card or money card with a contactless or contact-based interface to the reading/writing device. The value card in conjunction with the wireless communication between the interface and the car park fee center, such as via a WLAN (wireless local area network) enables the user to complete his payment of the parking fee in a cashless manner. Further the system may include a second selection unit for a user to preselect, whether the system shall be activated, thereby avoiding unnecessary sensory overload and unnecessary computing effort.

The conclusion can thus be drawn that a method and a system for providing information about parking fees on a metered car park according to the present disclosure can be designed in a simple manner and with which the comfort for the user can be distinctly increased. Thus the comfort for a user is distinctly increased because superfluous walks to a car park fee center associated with the car park, such as a parking ticket machine, are no longer necessary and in addition parking data such as zone and number of the chosen car park are detected automatically via components and functions of the motor vehicle without necessitating a separate input of parking data by the user of the motor vehicle.

Furthermore the method and the system are designed in such a way that these are realized and executed by components and functions of driver assistance systems known for conventional motor vehicles without requiring expensive and costly conversions.

### BRIEF DESCRIPTION OF THE DRAWINGS

The present disclosure shall now be described in detail with reference to the figures.

FIG. 1 shows a schematic block diagram of a system for providing information about parking fees in a metered car park according to embodiments of the present disclosure; and

FIG. 2 shows a flow diagram of a method for providing information about parking fees in a metered car park according to embodiments of the present disclosure.

### DETAILED DESCRIPTION

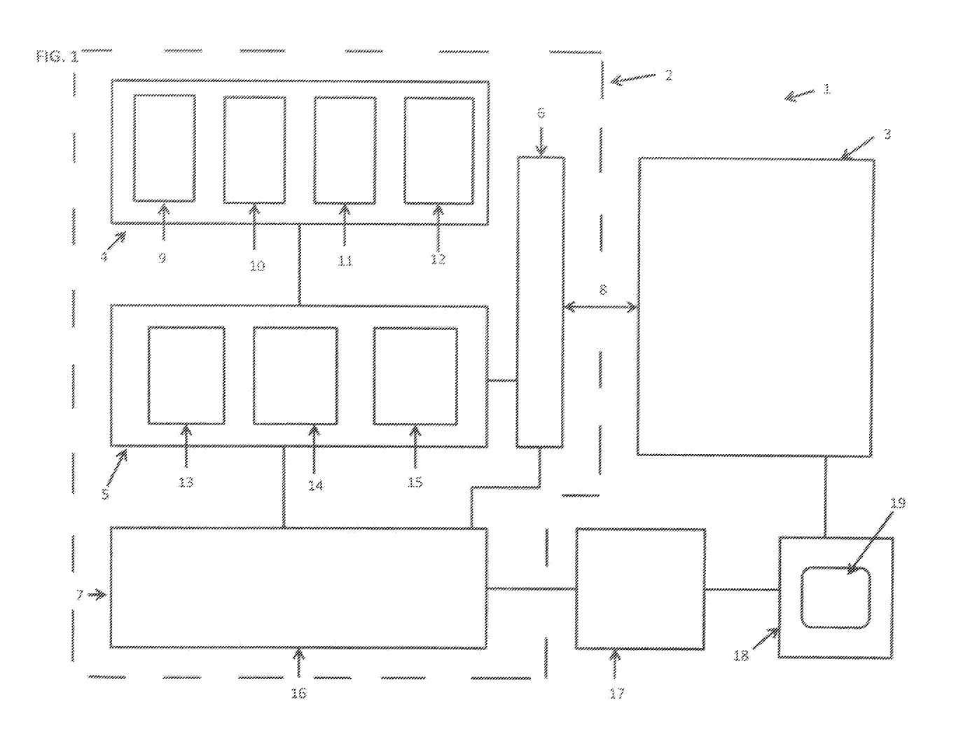

FIG. 1 shows a schematic block diagram of a system 1 for providing information about parking fees in a metered car park according to embodiments of the present disclosure.

Such a system 1 includes on-board components which are symbolized by the broken line marked with the reference symbol 2, and a car park fee center 3 associated with the car park. The car park fee center 3 is understood to be a facility which is firmly associated with the respective car park, and which provides data in particular about parking fees, for example a parking ticket machine. As shown in FIG. 1, the on-board components include a first means 4 for detecting whether a motor vehicle is present in a metered car park and a second means 5 coupled with the first means 4 for detecting whether the motor vehicle is parked, in case the motor vehicle is present in a metered car park. Further an interface 6 coupled with the second means 5 can be recognized which serves to establish a wireless link to the car park fee center 3 and an indicating means 7 for providing information about parking fees, in case the motor vehicle is parked. The wireless link is symbolized by an arrow marked with the reference symbol 8. The interface 6 and the indicating means 7 may also be integrated with a mobile terminal not shown in FIG. 1.

The shown first means 5 includes a memory 9 for storing a digital map, means for position determination 10, a web interface 11 as well as a first evaluation unit 12 for comparing an actual vehicle position with known map data. Known map data is understood to mean data of a digital map as well as additional information, which is POI information or web information. POI (point of interest) information is understood to be locations which could be of importance for the user of a map or a navigation system and which are normally represented in the map as small icons. The means for position determination 10 is understood to be a GPS (global positioning system) module. Further modules for position determination could also be utilized, such as a GLONASS (global navigation satellite system) module and/or a compass module and/or a Galileo module and/or an IRNSS (Indian regional navigation satellite system) module and/or an EGNOS (European geostationary navigation overlay service) module and/or a GAGAN (GPS added Geo augmented navigation) module and/or a WAAS (wide area augmentation system) module. Thus it is easy to detect with the aid of known and commonly used components and functions of known and commonly used driver assistance systems, whether the motor vehicle is present in a metered car park, wherein the comfort for the user is increased because a separate input of parking data, e.g. zone and number of the car park by the user of the motor vehicle, is longer necessary.

The shown second means 5 includes a hand brake sensor 13, an engine control 14 as well as a second evaluation unit 15 for evaluating the data of the hand brake sensor 13 and/or the engine control 14. Since hand brakes are usually only operated for securing a parked vehicle and a vehicle speed can be ascertained from data of an engine control 14 it is possible to deduct whether the motor vehicle is at all moving. For this reason the second means 5 is designed to detect data from components and functions present in conventional vehicles, whether the motor vehicle has been parked. Further the second evaluation unit 15 may be configured to evaluate data of sensors present in conventional motor vehicles in order to detect, whether the motor vehicle is parked.

Further, the indicating means 7 shown in FIG. 1 is a screen 16 of an information/entertainment system of the motor vehicle. Also the indicating means 7 may be a display unit of a mobile terminal so that a user of the motor vehicle may obtain information about parking fees in a metered car park, independently of whether the user has already left the motor vehicle. The mobile terminal is a portable unit which the user can carry with him, for example a mobile phone, a PDA (personal digital assistant) or a smartphone. Also other information may be provided, such as information about the infrastructure of the car park or a maximum possible parking duration, and this information can be made available on the mobile terminal for further applications, e.g. for an application for finding the way back to the motor vehicle in a car park.

The system in FIG. 1 also includes a first selection unit 17 for the user to select whether a parking ticket shall be acquired as well as a third means 18 for cashless payment of the parking fee via the wireless link. Thus the user has the choice as to whether to buy a parking ticket. In the embodiments shown the first selection unit 17 and the third means 18 are components of the information/entertainment system of the motor vehicle. Further the first selection unit and the third means may also be incorporated in the mobile terminal It is feasible to acquire a parking ticket for a desired parking duration directly upon parking for a certain parking duration or to pay the accrued parking fee in a cashless manner when driving the car out of the car park. In order to pay the parking fee due in a cashless manner, the shown third means 18 includes a reading/writing device 19 for a card with payment function. The card may be configured as a credit card, money card, EC card or other smartcard and may include a contactless or contact-based interface to the reading/writing device 19.

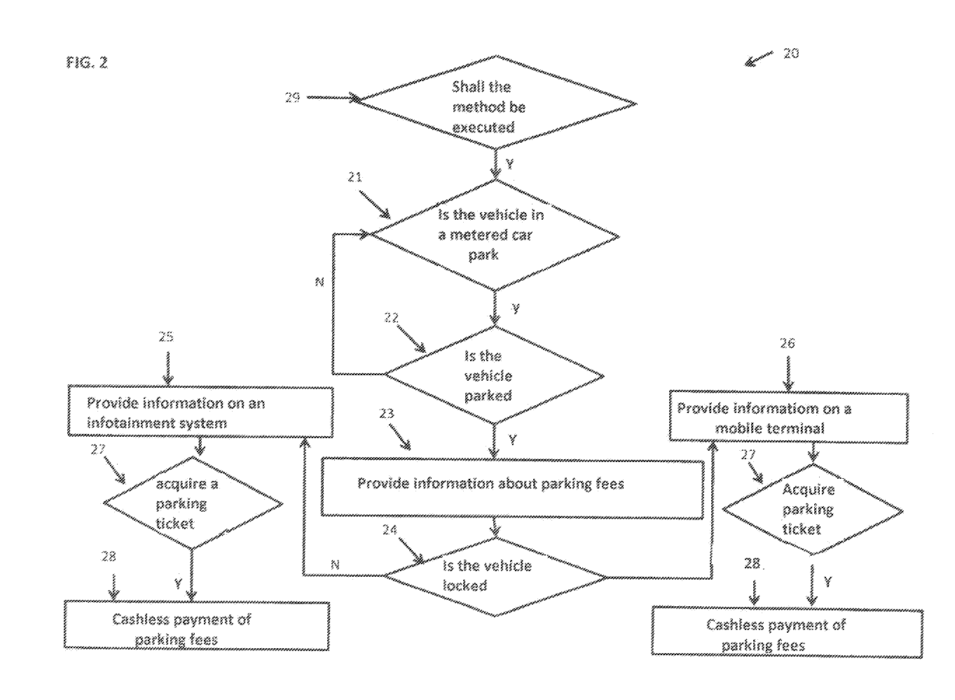

FIG. 2 shows s flow diagram of a method 20 for providing information about parking fees in a metered car park.

As shown in FIG. 2, the method 20 includes the following steps: Initially an on-board detection is made whether a motor vehicle is present 21 in a metered car park, and subsequently if the motor vehicle is in a metered car park, an on-board detection is made whether the motor vehicle is parked 22. Then, in case the motor vehicle is parked a wireless link is established to a car park fee center associated with the car park and information is received 23 regarding the parking fees via the wireless link. On-board in this case means that the steps are executed via components and/or functions of the motor vehicle.

Step 21 of on-board detecting whether the motor vehicle is present in a metered car park includes, according to the embodiments of FIG. 1, a comparison of an actual vehicle position with known map data.

Known map data is understood to mean data of a digital map as well as additional information which is POI information and/or web information. POI (point of interest) relates to locations which may be of importance for the user of a map or a navigation system and which is represented in the map by small icons.

If it is ascertained in step 21 that the motor vehicle is in a metered car park, step 21 is repeatedly executed. If it is detected that the motor vehicle is in a metered car park, it is detected in step 22 whether the vehicle is parked, which according to the embodiments of FIG. 2 is affected on the basis of data of vehicle sensors.

According to the embodiments of FIG. 2 the data of the vehicle sensors is data of a hand brake sensor and/or data of an engine control. Since hand brakes are normally only operated for securing a parked vehicle, and the vehicle speed can be obtained from data of an engine control, it can be ascertained whether the motor vehicle is at all moving, and therefore it can be detected on the basis of data from sensors present in conventional motor vehicles whether the vehicle has been parked.

If it is ascertained in this step 22 that the motor vehicle has not been parked steps 21 and 22 are executed repeatedly. If, however, it is ascertained in step 22 that the vehicle has been parked, then information about parking fees is received in a following step 23. As shown in FIG. 2, step 23 includes the following further method steps: in step 24 it is detected whether the motor vehicle is locked. If it is detected in step 24 that the vehicle is not locked, the information is provided on a screen of an information/entertainment system of the motor vehicle in a following step 25. If, however, it is detected in step 24 that the motor vehicle is locked, the information is provided on a display unit of a mobile terminal in the following step 26.

The embodiments shown in FIG. 2 further include the following method steps: a user selects whether a parking ticket shall be bought 27, and parking fees are paid via the wireless link in a cashless manner in case a parking ticket shall be bought 28.

The flow diagram also shows the optional step 29 of pre-selection by a user whether the method shall be performed. Consequently the steps 21 to 28 are not performed until this has been selected by the user and is thus desired, thereby preventing unnecessary sensory overload and unnecessary computing capacity.

Although at least one exemplary embodiment has been described in the above description, various alterations and modifications can be performed. The mentioned embodiments are merely examples and are not intended to restrict the scope, the applicability or the configuration in any way. Rather the above description is intended to submit to the expert a plan for translating at least one exemplary embodiment, wherein numerous alterations can be made to the function and arrangement of elements described in an exemplary embodiment without deviating from the scope of protective of the attached claims and their legal equivalents.

1-15. (canceled)

16. A method for providing information about parking fees in a metered car park, wherein the method comprises:
determining whether a motor vehicle is in a metered car park using an on-board detection;
determining whether the motor vehicle is parked, in case the motor vehicle is in a metered car park using an on-board detection;
establishing a wireless link to a car park fee center associated with a car park; and
receiving parking fee information via the wireless link when the motor vehicle is parked.

17. The method according to claim 16, further comprising a comparison of an actual vehicle position with known map data for determining whether the motor vehicle is in a metered car park using an on-board detection.

18. The method according to claim 17, wherein the known map data is data of a digital card and additional information selected from the group consisting of POI information, web information and combinations thereof

19. The method according to claim 16, wherein detecting whether the vehicle is parked, is affected on the basis of data from vehicle sensors.

20. The method according to claim 19, wherein the data from vehicle sensors is data acquired from at least one of a hand brake sensor and an engine controller.

21. The method according to claim 16, wherein receiving information about the parking fees further comprises:
detecting whether the motor vehicle is locked or not locked;
providing information on a screen of the motor vehicle when the motor vehicle is not locked; and
providing information on a display unit of a mobile terminal when the motor vehicle is locked.

22. The method according claim 16, wherein the method further comprises:
indicating that a parking ticket is to be purchased; and
paying a parking fee for the parking ticket in a cashless manner via a wireless link.

23. The method according to claim 16, wherein the method further comprises pre-selecting whether the method shall be executed.

24. A non-transitory computer readable medium containing a program which when executed on a computer unit of a motor vehicle, instructs the computer unit to execute a method a method comprising:
determining whether a motor vehicle is in a metered car park using an on-board detection;
determining whether the motor vehicle is parked, in case the motor vehicle is in a metered car park using an on-board detection;
establishing a wireless link to a car park fee center associated with a car park; and
receiving parking fee information via the wireless link when the motor vehicle is parked.

25. A system for providing information about parking fees in a metered car park comprising:
an on-board vehicle locator to detect when a motor vehicle is in a metered car park;
an on-board parking evaluator to detect when the motor vehicle is parked;
an interface for establishing a wireless link to a car park fee center associated with a car park; and
a display to provide information about the parking fees.

26. The system according to claim 25, wherein the on-board vehicle locator comprises a memory for storing a digital map with known map data, a vehicle positioning system acquiring an actual vehicle position, and a position evaluation unit comparing the actual vehicle position with known map data to detect when a motor vehicle is in a metered car park.

27. The system according to claim 25, wherein on-board parking evaluator comprises a hand brake sensor, an engine controller, and a parked evaluation unit evaluating data of at least one of the hand brake sensor and the engine controller to detect when the motor vehicle is parked.

28. The system according to claim 25, wherein the display is at least one of a screen for an information/entertainment system of the motor vehicle and a display unit in a mobile terminal.

29. The system according to claim 25, wherein the system further comprises a selection unit to select whether a parking ticket is purchased and a payment system to pay a parking fee in a cashless manner via a wireless link.
